(19) United States
(12) Patent Application Publication
(10) Pub. No.: US 2019/0027288 A1
(43) Pub. Date: Jan. 24, 2019

(54) COIL COMPONENT

(71) Applicant: TAIYO YUDEN CO., LTD., Tokyo (JP)

(72) Inventors: Natsuko SATO, Tokyo (JP); Satoshi TOKUNAGA, Tokyo (JP); Satoshi KOBAYASHI, Tokyo (JP)

(21) Appl. No.: 16/042,358

(22) Filed: Jul. 23, 2018

(30) Foreign Application Priority Data
Jul. 24, 2017 (JP) 2017-142416

(51) Int. Cl. H01F 5/04; H01F 38/14; H01F 27/32

(52) U.S. Cl. CPC H01F 5/04; H01F 38/14; H01F 2017/0093; H01F 27/327; H01F 27/324

(57) ABSTRACT

One object is to provide a magnetic coupling coil component having an improved coupling coefficient. A coil component according to one embodiment of the present invention includes: an insulator body; and first and second coil conductors embedded in the insulator body and wound around a coil axis. A first coil surface of the first coil conductor is opposed to a second coil surface of the second coil conductor. The insulator body includes: an intermediate portion disposed between the first coil surface and the second coil surface; a core portion disposed inside the first and second coil conductors; and an outer peripheral portion disposed outside the first and second coil conductors. A magnetic permeability of the intermediate portion in a direction perpendicular to the coil axis is smaller than those of the core portion and the outer peripheral portion in a direction parallel to the coil axis.

### CROSS-REFERENCE TO RELATED APPLICATIONS

This application is based on and claims the benefit of priority from Japanese Patent Application Serial No. 2017-142416 (filed on Jul. 24, 2017), the contents of which are hereby incorporated by reference in their entirety.

### TECHNICAL FIELD

The present invention relates to a coil component, and in particular to a magnetic coupling coil component including a pair of coil conductors magnetically coupled to each other.

### BACKGROUND

A magnetic coupling coil component includes a pair of coil conductors magnetically coupled to each other. Examples of magnetic coupling coil component including a pair of coil conductors magnetically coupled to each other include a common mode choke coil, a transformer, and a coupled inductor. In most cases, such a magnetic coupling coil component preferably has a high coupling coefficient between the pair of coil conductors.

There has been conventionally known an assembled coupled inductor. Examples of assembled coupled inductor are disclosed in Japanese Patent Application Publication No. 2005-129590 (“the '590 Publication”) and Japanese Patent Application Publication No. 2009-117676 (“the '676 Publication”). As disclosed in these literatures, an assembled coupled inductor includes two plate-shaped conductors and a pair of magnetic members (a lower magnetic member and an upper magnetic member) sandwiching the two conductors. In the '590 Publication and the '676 Publication, it is proposed that a magnetic gap be provided between the two conductors to increase the coupling coefficient between the two conductors. In the coupled inductors disclosed in these literatures, the magnetic gap between the two conductors reduces leakage inductance between the two conductors.

However, in assembled coupled inductors, there are limits of accuracy in working and assembling the two conductors and the magnetic members, and therefore, it is difficult to provide the magnetic gaps with a constant size and a constant arrangement. This makes it difficult to obtain a constant coupling coefficient in assembled coupled inductors.

Further, assembled magnetic coupling coil components are less susceptible to downsizing as compared to laminated coil components produced by a lamination process and thin film coil components produced by a thin film process.

A magnetic coupling coil component produced by a lamination process is disclosed in Japanese Patent Application Publication No. 2016-131208 (“the '208 Publication”). This coupling coil component includes a plurality of laminated coil units embedded in an insulator. The plurality of coil units are configured such that the winding axes of the coil conductors of the coil units are substantially aligned with each other and the coil units are tightly contacted with each other, thereby facilitating coupling between the coil conductors.

In the conventional magnetic coupling coil component as disclosed in the '208 Publication, a leakage magnetic flux passing between the two coil conductors produces a leakage inductance. The leakage inductance degrades the coupling coefficient in the magnetic coupling coil component.

As described above, it is required to facilitate coupling between two coil conductors in a magnetic coupling coil component. There is also a high demand for downsizing magnetic coupling coil components.

### SUMMARY

One object of the present invention is to improve magnetic coupling coil components. One particular object of the present invention is to provide a magnetic coupling coil component having an improved coupling coefficient. Another particular object of the present invention is to provide a downsized magnetic coupling coil component having an improved coupling coefficient. Other objects of the present invention will be apparent with reference to the entire description in this specification.

A coil component according to one embodiment of the present invention comprises: an insulator body; a first coil conductor embedded in the insulator body and wound around a coil axis; and a second coil conductor embedded in the insulator body and wound around the coil axis. A first coil surface of the first coil conductor is opposed to a second coil surface of the second coil conductor. The insulator body includes: an intermediate portion disposed between the first coil surface and the second coil surface; a core portion disposed inside the first coil conductor and the second coil conductor; and an outer peripheral portion disposed outside the first coil conductor and the second coil conductor. A magnetic permeability of the intermediate portion in a direction perpendicular to the coil axis is smaller than those of the core portion and the outer peripheral portion in a direction parallel to the coil axis. The magnetic permeability of the intermediate portion in any direction perpendicular to the coil axis and centered at the coil axis may be smaller than those of the core portion and the outer peripheral portion in the direction parallel to the coil axis, and the average magnetic permeability of the intermediate portion in the direction perpendicular to the coil axis may be smaller than the average magnetic permeability of the core portion in the direction parallel to the coil axis and the average magnetic permeability of the outer peripheral portion in the direction parallel to the coil axis. The average magnetic permeability of the intermediate portion in the direction perpendicular to the coil axis may be the average of the magnetic permeability in a first direction perpendicular to the coil axis and the magnetic permeability in a second direction perpendicular to the coil axis. The first direction and the second direction may be perpendicular to each other. In one embodiment of the present invention, the intermediate portion is formed of a non-magnetic material. In one embodiment of the present invention, the intermediate portion is formed of an anisotropic magnetic material having an easy magnetization direction parallel to the coil axis.

According to the above embodiment, the magnetic flux generated from the first coil conductor does not pass through the intermediate portion disposed between the first coil conductor and the second coil conductor but passes through a closed magnetic path liked with the second coil conductor. Therefore, less leakage magnetic flux occurs between the first coil conductor and the second coil conductor. Therefore, in the coil component according to the above embodiment, the coupling coefficient can be improved as compared to conventional magnetic coupling coil components.

In one embodiment of the present invention, the intermediate portion has a larger resistance value than the core portion. In one embodiment of the present invention, the intermediate portion has a larger resistance value than the outer peripheral portion.

According to the above embodiment, even when the intermediate portion has a small thickness, electric insulation between the first coil conductor and the second coil conductor can be ensured. Therefore, the coil component can be reduced in size (profile).

A coil component according to another embodiment of the present invention comprises: an insulator body; an insulating substrate embedded in the insulator body; a first coil conductor formed on one surface of the insulating substrate and wound around a coil axis; and a second coil conductor formed on another surface of the insulating substrate and wound around the coil axis. A magnetic permeability of the insulating substrate in a direction perpendicular to the coil axis is smaller than that in a direction parallel to the coil axis.

According to the above embodiment, the magnetic flux generated from the first coil conductor passes through the insulating substrate in the direction parallel to the coil axis, not in the direction perpendicular to the coil axis. Therefore, less leakage magnetic flux occurs between the first coil conductor and the second coil conductor. Therefore, in the coil component according to the above embodiment, the coupling coefficient can be improved as compared to conventional magnetic coupling coil components.

### Advantages

According to one embodiment of the present invention, a magnetic coupling coil component having an improved coupling coefficient can be obtained.

### BRIEF DESCRIPTION OF THE DRAWINGS

FIG. 1 is a perspective view of a coil component according to one embodiment of the present invention.

FIG. 2 is an exploded perspective view of one of two coil units included in the coil component of FIG. 1.

FIG. 3 is an exploded perspective view of the other of the two coil units included in the coil component of FIG. 1.

FIG. 4 schematically shows a cross section of the coil component of FIG. 1 cut along the line I-I.

FIG. 5 schematically shows a cross section of a coil component according to another embodiment of the present invention.

FIG. 6 is a perspective view of the coil component according to still another embodiment of the present invention.

FIG. 7 schematically shows a cross section of the coil element of FIG. 6 cut along the line II-II.

### DESCRIPTION OF THE EMBODIMENTS

Various embodiments of the invention will be described hereinafter with reference to the drawings. Elements common to a plurality of drawings are denoted by the same reference signs throughout the plurality of drawings. It should be noted that the drawings do not necessarily appear in accurate scales, for convenience of description.

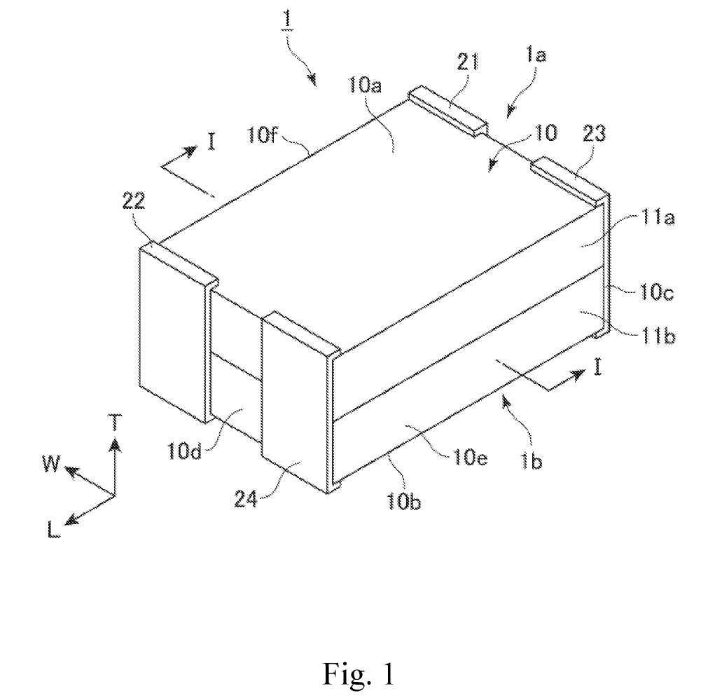

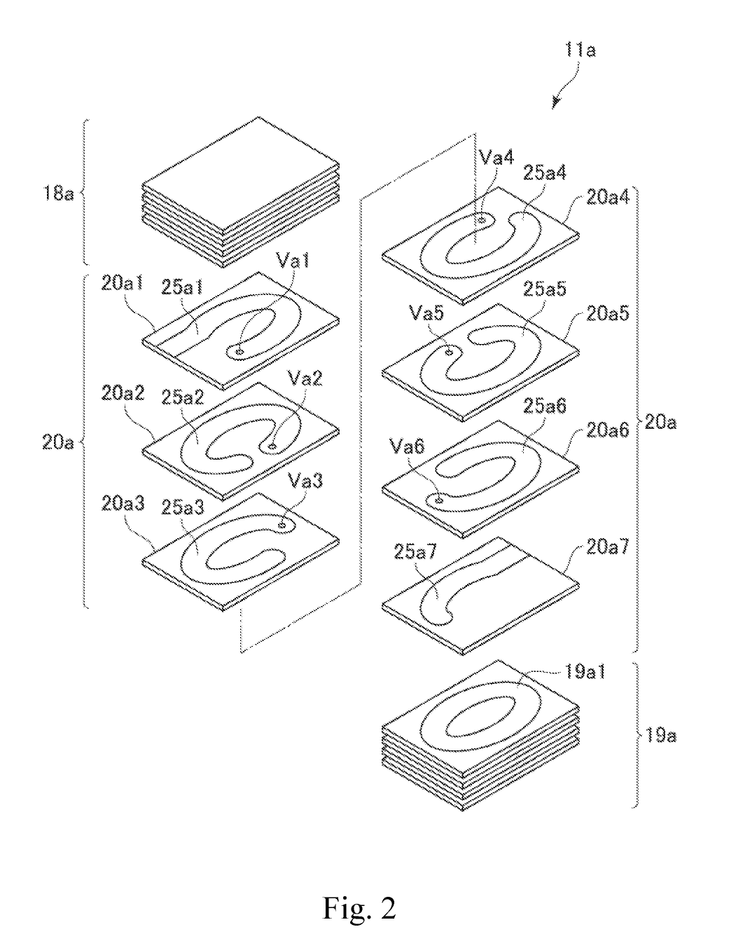

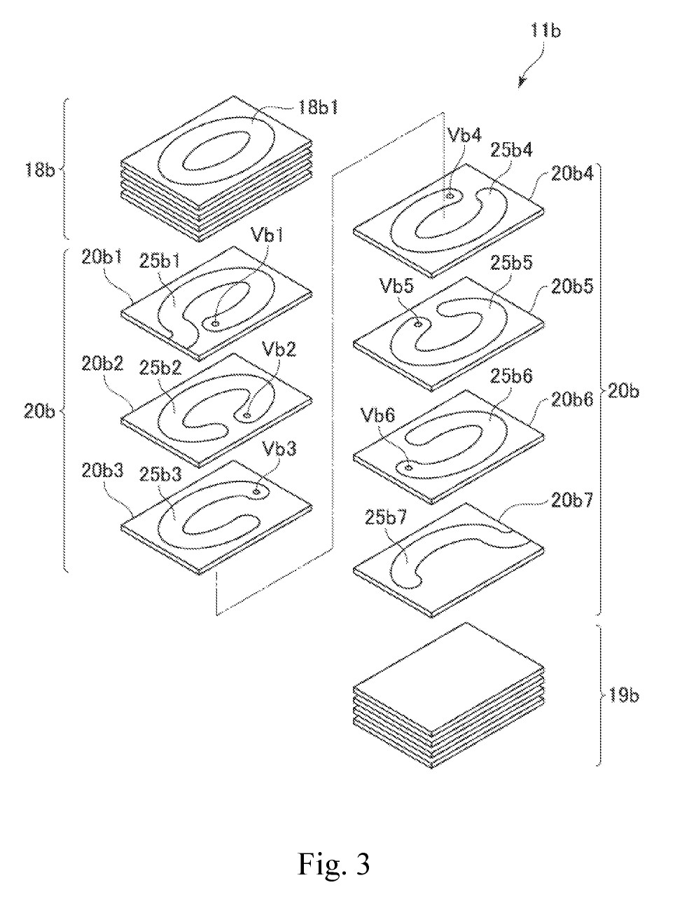

A coil component 1 according to one embodiment of the present invention will be hereinafter described with reference to FIGS. 1 to 3. FIG. 1 is a perspective view of a coil component 1 according to one embodiment of the present invention, FIG. 2 is an exploded perspective view of a coil unit 1a included in the coil component 1 of FIG. 1, and FIG. 3 is an exploded perspective view of a coil unit 1b included in the coil component 1 of FIG. 1.

These drawings show, as one example of the coil component 1, a common mode choke coil for eliminating common mode noise from a differential transmission circuit that transmits a differential signal. A common mode choke coil is one example of a magnetic coupling coil component to which the present invention is applicable. As will be described later, a common mode choke coil is produced by a lamination process or a thin film process. The present invention can also be applied to a transformer, a coupling inductor, and other various coil components, in addition to a common mode choke coil.

As shown, the coil component 1 according to one embodiment of the present invention includes the coil unit 1a and the coil unit 1b.

The coil unit 1a includes an insulator body 11a made of a magnetic material having an excellent insulating quality, a coil conductor 25a embedded in the insulator body 11a, an external electrode 21 electrically connected to one end of the coil conductor 25a, and an external electrode 22 electrically connected to the other end of the coil conductor 25a. The insulator body 11a has a rectangular parallelepiped shape.

The coil unit 1b is configured in the same manner as the coil unit 1a. More specifically, the coil unit 1b includes an insulator body 11b made of a magnetic material, a coil conductor 25b embedded in the insulator body 11b, an external electrode 23 electrically connected to one end of the coil conductor 25b, and an external electrode 24 electrically connected to the other end of the coil conductor 25b. The insulator body 11b has a rectangular parallelepiped shape.

The bottom surface of the insulator body 11a is joined to the top surface of the insulator body 11b. The insulator body 11a and the insulator body 11b are joined to each other to constitute an insulator body 10. Accordingly, the insulator body 10 includes the insulator body 11a and the insulator body 11b joined to the insulator body 11a.

The insulator body 10 has a first principal surface 10a, a second principal surface 10b, a first end surface 10c, a second end surface 10d, a first side surface 10e, and a second side surface 10f. The outer surface of the insulator body 10 is defined by these six surfaces. The first principal surface 10a and the second principal surface 10b are opposed to each other, the first end surface 10c and the second end surface 10d are opposed to each other, and the first side surface 10e and the second side surface 10f are opposed to each other.

In FIG. 1, the first principal surface 10a lies on the top side of the insulator body 10, and therefore, the first principal surface 10a may be herein referred to as “the top surface.” Similarly, the second principal surface 10b may be referred to as “the bottom surface.” The coil component 1 is disposed such that the second principal surface 10b faces a circuit board (not shown), and therefore, the second principal surface 10b may be herein referred to as “the mounting surface.” Furthermore, the top-bottom direction of the coil component 1 refers to the top-bottom direction in FIG. 1.

In this specification, the “length” direction, the “width” direction, and the “thickness” direction of the coil component 1 refer to the “L” direction, the “W” direction, and the “T” direction in FIG. 1, respectively, unless otherwise construed from the context.

The external electrode 21 and the external electrode 23 are provided on the first end surface 10c of the insulator body 10. The external electrode 22 and the external electrode 24 are provided on the second end surface 10d of the insulator body 10. As shown, each of these external electrodes extends onto the top surface and the bottom surface of the insulator body 10.

As shown in FIG. 2, the insulator body 11a includes an insulator portion 20a, a top cover layer 18a provided on the top surface of the insulator portion 20a, and a bottom cover layer 19a provided on the bottom surface of the insulator portion 20a.

The insulator portion 20a includes insulating layers 20a1 to 20a7 stacked together. The insulator body 11a includes the top cover layer 18a, the insulating layer 20a1, the insulating layer 20a2, the insulating layer 20a3, the insulating layer 20a4, the insulating layer 20a5, the insulating layer 20a6, the insulating layer 20a7, the bottom cover layer 19a that are stacked in this order from the positive side to the negative side in the direction of the axis T.

The insulating layers 20a1 to 20a7 contain a resin and a large number of filler particles. The filler particles are dispersed in the resin. The insulating layers 20a1 to 20a7 may not contain the filler particles.

In one embodiment of the present invention, the insulating layers 20a1 to 20a7 may contain flat-shaped filler particles. The flat-shaped filler particles are contained in the insulating layers so as to assume such a position that the longest axes thereof are parallel to the axis T (corresponding to the coil axis CL described later) and the short axes thereof are perpendicular to the coil axis CL. With the filler particles made of the magnetic material assuming such a position, the magnetic permeability of individual ones of the insulating layers 20a1 to 20a7 in the direction parallel to the axis T is larger than that in the direction perpendicular to the axis T. Thus, the insulating layers 20a1 to 20a7 have an easy magnetization direction parallel to the axis T and a hard magnetization direction perpendicular to the axis T. To ensure that the insulating layers 20a1 to 20a7 have an easy magnetization direction parallel to the axis T and a hard magnetization direction perpendicular to the axis T, it is not necessary that all the filler particles contained in the insulating layers 20a1 to 20a7 have the longest axes thereof oriented accurately perpendicular to the axis T.

On the top surfaces of the insulating layers 20a1 to 20a7, there are provided conductive patterns 25a1 to 25a7, respectively. The conductive patterns 25a1 to 25a7 are formed by applying a conductive paste made of a metal or alloy having an excellent electrical conductivity by screen printing. The conductive paste may be made of Ag, Pd, Cu, Al, or an alloy thereof. The conductive patterns 25a1 to 25a7 may be formed by other methods using other materials.

The insulating layers 20a1 to 20a6 are provided with vias Va1 to Va6, respectively, at predetermined positions therein. The vias Va1 to Va6 are formed by drilling through-holes at predetermined positions in the insulating layers 20a1 to 20a6 so as to extend through the insulating layers 20a1 to 20a6 in the direction of the axis T and filling the conductive paste into the through-holes.

Each of the conductive patterns 25a1 to 25a7 is electrically connected to adjacent ones via the vias Va1 to Va6. The conductive patterns 25a1 to 25a7 connected in this manner form a coil conductor 25a having a spiral shape. In other words, the coil conductor 25a includes the conductor patterns 25a1 to 25a7 and the vias Va1 to Va6.

The end of the conductive pattern 25a1 opposite to the other end connected to the via Va1 is connected to the external electrode 22. The end of the conductive pattern 25a7 opposite to the other end connected to the via Va6 is connected to the external electrode 21.

The top cover layer 18a is a laminate including a plurality of insulating layers stacked together. Similarly, the bottom cover layer 19a is a laminate including a plurality of insulating layers stacked together. Each of the insulating layers constituting the top cover layer 18a and the bottom cover layer 19a is made of a resin containing a large number of filler particles dispersed therein. These insulating layers may not contain the filler particles.

In one embodiment of the present invention, the bottom cover layer 19a includes an annular portion 19a1 having an annular shape in plan view. The shape of the annular portion 19a1 corresponds to the plane shape of the coil conductor 25a in plan view. For example, the coil conductor 25a has a spiral shape formed by connecting the conductive patterns 25a1 to 25a7 via the vias Va1 to Va6, the spiral shape appearing nearly oval in plan view. In this case, the annular portion 19a1 has an oval shape that corresponds to the shape of the coil conductor 25a in plan view. The annular portion 19a1 is positioned inside the outline of the plane shape of the coil conductor 25a in plan view. For example, the annular portion 19a1 has an oval shape with a long axis and a short axis slightly shorter than those of the oval defining the outline of the coil conductor 25a.

In one embodiment of the present invention, the annular portion 19a1 is formed of a non-magnetic material. The non-magnetic material forming the annular portion 19a1 may be glass, Zn ferrite, or other well known non-magnetic materials. The non-magnetic material forming the annular portion 19a1 may include particles of metal oxides such as silica particles, zirconia particles, and alumina particles.

In one embodiment of the present invention, the annular portion 19a1 is formed of an anisotropic magnetic material having an easy magnetization direction parallel to the coil axis CL. The anisotropic magnetic material is, for example, a composite magnetic material containing a resin and flat-shaped filler particles. The filler particles are contained in the resin and oriented so as to assume such a position that the longest axes thereof are parallel to the axis T and the short axes thereof are perpendicular to the coil axis CL. With the filler particles assuming such a position, a magnetic permeability of the annular portion 19a1 in the direction parallel to the axis T is larger than that in the direction perpendicular to the axis T. Thus, the annular portion 19a1 has an easy magnetization direction parallel to the axis T and a hard magnetization direction perpendicular to the axis T.

To ensure that the annular portion 19a1 has an easy magnetization direction parallel to the axis T and a hard magnetization direction perpendicular to the axis T, it is not necessary that all the filler particles contained in the annular portion 19a1 have the longest axes thereof oriented accurately perpendicular to the axis T.

The annular portion 19a1 is formed by preparing a plurality of sheets formed of the above non-magnetic material or the anisotropic magnetic material, cutting each of the plurality of sheets into the same shape as the coil conductor 25a in plan view (an annular shape in the illustrated embodiment), and stacking the cut sheets together. A resin containing filler particles is applied by printing around the annular portion 19a1 formed as described above, thereby to complete the bottom cover layer 19a.

The resin contained in the insulating layers 20a1 to 20a7, the insulating layers constituting the top cover layer 18a, the insulating layers constituting the bottom cover layer 19a, and the annular portion 19a1 is a thermosetting resin having an excellent insulating quality. Examples of such a resin include an epoxy resin, a polyimide resin, a polystyrene (PS) resin, a high-density polyethylene (HDPE) resin, a polyoxymethylene (POM) resin, a polycarbonate (PC) resin, a polyvinylidene fluoride (PVDF) resin, a phenolic resin, a polytetrafluoroethylene (PTFE) resin, or a polybenzoxazole (PBO) resin. The resin contained in one sheet is either the same as or different from the resin contained in another sheet.

The filler particles contained in the insulating layers 20a1 to 20a7, the insulating layers constituting the top cover layer 18a, the bottom cover layer 19a, and the annular portion 19a1 are particles of a ferrite material, metal magnetic particles, particles of an inorganic material such as SiO₂ or Al₂O₃, or glass-based particles. Particles of a ferrite material applicable to the present invention are, for example, particles of Ni—Zn ferrite or particles of Ni—Zn—Cu ferrite. Metal magnetic particles applicable to the present invention are made of a material in which magnetism is developed in an unoxidized metal portion, and are, for example, particles including unoxidized metal particles or alloy particles. Metal magnetic particles applicable to the present invention include particles of, for example, a Fe—Si—Cr, Fe—Si—At or Fe—Ni alloy, a Fe—Si—Cr—B—C or Fe—Si—B—Cr amorphous alloy, Fe, or a mixture thereof. Metal magnetic particles applicable to the present invention further include particles of Fe—Si—Al or Fe—Si—Al—Cr. Powder compacts made of these types of particles can also be used as the metal magnetic particles of the present invention. Moreover, these types of particles or powder compacts each having a surface thermally treated to form an oxidized film thereon can also be used as the metal magnetic particles of the present invention. The metal magnetic particles applicable to the present invention are manufactured by, for example, an atomizing method. Furthermore, the metal magnetic particles applicable to the present invention can be manufactured by a known method. Furthermore, commercially available metal magnetic particles can also be used in the present invention. Examples of commercially available metal magnetic particles include PF-20F manufactured by Epson Atmix Corporation and SFR-FeSiAl manufactured by Nippon Atomized Metal Powders Corporation.

The flat-shaped filler particles contained in the insulating layers 20a1 to 20a7 and the annular portion 19a1 have an aspect ratio (a flattening ratio) of, for example, 1.5 or more, 2 or more, 3 or more, 4 or more, or 5 or more. An aspect ratio of filler particles refers to a length of the particles in a longest axis direction with respect to a length thereof in a shortest axis direction (a length in the longest axis direction/a length in the shortest axis direction).

As described above, the annular portion 19a1 is formed of a non-magnetic material or an anisotropic magnetic material having an easy magnetization direction parallel to the axis T (the coil axis CL). In one embodiment of the present invention, the magnetic permeability of the annular portion 19a1 in the direction perpendicular to the axis T is smaller than that of the insulator portion 20a in the direction parallel to the axis T (the coil axis CL) and that of the bottom cover layer 19a in the direction parallel to the axis T (the coil axis CL). The magnetic permeability of the annular portion 19a1 in any direction perpendicular to the axis T and centered at the axis T may be smaller than that of the insulator portion 20a in the direction parallel to the axis T and that of the bottom cover layer 19a in the direction parallel to the axis T. When the magnetic permeability of the annular portion 19a1 in the direction perpendicular to the axis T is anisotropic, the average magnetic permeability of the annular portion 19a1 in the direction perpendicular to the axis T should be smaller than the average magnetic permeability of the insulator portion 20a in the direction parallel to the axis T and the average magnetic permeability of the bottom cover layer 19a in the direction parallel to the axis T. The average magnetic permeability of the annular portion 19a1 in the direction perpendicular to the axis T may be the average of the magnetic permeability in a first direction perpendicular to the axis T and the magnetic permeability in a second direction perpendicular to the axis T. The first direction and the second direction may be perpendicular to each other. For example, the first direction is the direction of the axis W, and the second direction is the direction of the axis L.

In one embodiment of the present invention, the annular portion 19a1 has a larger resistance value than the insulator portion 20a and the bottom cover layer 19a.

As described above, the coil unit 1b is configured in the same manner as the coil unit 1a. More specifically, the insulator body 11b includes an insulator portion 20b, a top cover layer 18b provided on a top surface of the insulator portion 20b, and a bottom cover layer 19b provided on a bottom surface of the insulator portion 20b. The insulator portion 20b is configured in the same manner as the insulator portion 20a. More specifically, the insulator portion 20b includes insulating layers 20b1 to 20b7 stacked together, and each of the insulating layers 20b1 to 20b7 is configured in the same manner as the corresponding one of the insulating layers 20a1 to 20a7.

The coil conductor 25b is also configured in the same manner as the coil conductor 25a. More specifically, the coil conductor 25b includes conductive patterns 25b1 to 25b7. Each of the conductive patterns 25b1 to 25b7 is formed on the top surface of the corresponding one of the insulating layers 20b1 to 20b7. Each of the conductive patterns 25b1 to 25b7 is electrically connected to adjacent ones via the vias Vb1 to Vb6. The end of the conductive pattern 25b1 opposite to the other end connected to the via Vb1 is connected to the external electrode 24. The end of the conductive pattern 25b7 opposite to the other end connected to the via Vb6 is connected to the external electrode 23.

The bottom cover layer 19b is configured in the same manner as the top cover layer 18a. More specifically, the bottom cover layer 19b is a laminate including a plurality of insulating layers stacked together.

The top cover layer 18b is configured in the same manner as the bottom cover layer 19a. More specifically, the top cover layer 18b is a laminate including a plurality of insulating layers stacked together. In one embodiment of the present invention, the top cover layer 18b includes an annular portion 18b1 having an annular shape in plan view. The shape of the annular portion 18b1 corresponds to the plane shape of the coil conductor 25b in plan view. In one embodiment of the present invention, the coil conductor 25b has the same plane shape as the coil conductor 25a. In this case, the annular portion 18b1 has the same plane shape as the annular portion 19a1. The annular portion 18b1 is positioned inside the outline of the plane shape of the coil conductor 25b in plan view. For example, the annular portion 18b1 has an oval shape with a long axis and a short axis slightly shorter than those of the oval defining the outline of the coil conductor 25b.

The annular portion 18b1 may be formed of the same material by the same method as the annular portion 19a1.

In one embodiment of the present invention, the annular portion 18b1 is formed of a non-magnetic material or an anisotropic magnetic material having an easy magnetization direction parallel to the axis T (the coil axis CL). In one embodiment of the present invention, the magnetic permeability of the annular portion 18b1 in the direction perpendicular to the axis T is smaller than those of the insulator portion 20b and the top cover layer 18b in the direction parallel to the axis T (the coil axis CL). The magnetic permeability of the annular portion 18b1 in any direction perpendicular to the axis T and centered at the axis T may be smaller than that of the insulator portion 20b in the direction parallel to the axis T and that of the top cover layer 18b in the direction parallel to the axis T. When the magnetic permeability of the annular portion 18b1 in the direction perpendicular to the axis T is anisotropic, the average magnetic permeability of the annular portion 18b1 in the direction perpendicular to the axis T should be smaller than the magnetic permeability of the insulator portion 20b in the direction parallel to the axis T and the magnetic permeability of the top cover layer 18b in the direction parallel to the axis T. The average magnetic permeability of the annular portion 18b1 in the direction perpendicular to the axis T may be the average of the magnetic permeability in a first direction perpendicular to the axis T and the magnetic permeability in a second direction perpendicular to the axis T. The first direction and the second direction may be perpendicular to each other. For example, the first direction is the direction of the axis W, and the second direction is the direction of the axis L.

In one embodiment of the present invention, the annular portion 18b1 has a larger resistance value than the insulator portion 20b and the top cover layer 18b.

Each of the constituents of the coil unit 1b is formed of the same material by the same method as the corresponding one of the constituents of the coil unit 1a. Therefore, those skilled in the art can grasp the materials and the production methods of the constituents of the coil unit 1b by referring to the explanation related to the constituents of the coil unit 1a.

The coil component 1 can be obtained by joining the coil unit 1a and the coil unit 1b described above. The coil component 1 includes a first coil (the coil conductor 25a) and a second coil (the coil conductor 25b), the first coil positioned between the external electrode 21 and the external electrode 22, the second coil positioned between the external electrode 23 and the external electrode 24. These two coils are respectively connected to two signal lines in a differential transmission circuit, for example. Thus, the coil component 1 can operate as a common mode choke coil.

The coil component 1 may include a third coil (not shown). The coil component 1 having the third coil additionally includes another coil unit configured in the same manner as the coil unit 1a. As with the coil unit 1a and the coil unit 1b, the additional coil unit includes a coil conductor that is connected to additional external electrodes. The coil component including three coils is used as a common mode choke coil for a differential transmission circuit having three signal lines, for example.

Next, a description is given of an example of a production method of the coil component 1. The coil component 1 can be produced by, for example, a lamination process. First, the coil unit 1a and the coil unit 1b are produced. Since the coil unit 1a and the coil unit 1b can be produced by the same method, only the production method of the coil unit 1a will be described.

Specifically, the coil unit 1a is produced through the following steps. The first step is to produce the insulating layers 20a1 to 20a7, the insulating layers constituting the top cover layer 18a, and the insulating layers constituting the bottom cover layer 19a.

More specifically, to produce these insulating layers, a thermosetting resin (e.g., epoxy resin) having filler particles dispersed therein is mixed with a solvent to produce a slurry. The filler particles have a spherical or flat shape. The slurry is applied to a surface of a base film made of a plastic and then dried, and the dried slurry is cut to a predetermined size to obtain magnetic sheets to be used as the insulating layers 20a1 to 20a7, the insulating layers constituting the top cover layer 18a, and the insulating layers constituting the bottom cover layer 19a. When the filler particles have a flat shape, the filler particles are oriented such that the longest axis direction thereof is parallel to the axis T (the coil axis CL). The filler particles are oriented by any known method such as magnetic ordering. In magnetic ordering, while the resin in the slurry retains fluidity, the filler particles can be oriented in a direction by applying in a given direction a magnetic field to the slurry formed into a predetermined shape.

Next, the annular portion 19a1 is formed in the insulating layers constituting the bottom cover layer 19a. The annular portion 19a1 is formed by preparing a plurality of sheets formed of the non-magnetic material or the anisotropic magnetic material, cutting each of the plurality of sheets into a shape corresponding to the shape of the coil conductor 25a in plan view (an annular shape in the illustrated embodiment), and stacking the cut sheets together.

The anisotropic magnetic material sheets include, for example, filler particles oriented such that the longest axes thereof are oriented in the thickness direction. In this case, the plurality of anisotropic magnetic material sheets cut into a predetermined shape are stacked together to form the annular portion 19a1 having an easy magnetization direction parallel to the thickness direction and a hard magnetization direction perpendicular to the thickness direction.

It is also possible to produce the annular portion 19a1 with anisotropic magnetic material sheets including filler particles oriented such that the short axes thereof are oriented in the thickness direction. In these anisotropic magnetic material sheets, the long axes of the filler particles are oriented in the surface direction (the direction perpendicular to the thickness direction). In this case, a plurality of such anisotropic magnetic material sheets are first stacked together to form a laminate. Next, the laminate is cut into sheets along the direction perpendicular to the lamination direction thereof to form sheet bodies. In the sheet bodies, the short axes of the filler particles are oriented in the surface direction of the sheet bodies. The sheet bodies are cut into a shape corresponding to the shape of the coil conductor 25a and stacked together to form the annular portion 19a1. In the annular portion 19a1 thus obtained, the short axes of the filler particles are oriented in the direction perpendicular to the axis T, and therefore, the easy magnetization direction is parallel to the thickness direction and the hard magnetization direction is perpendicular to the thickness direction. Accordingly, the average magnetic permeability of the annular portion 19a1 in the direction perpendicular to the axis T is smaller than the average magnetic permeability of the annular portion 19a1 in the direction parallel to the axis T.

The annular portion 19a1 may also be produced by other methods. For example, an anisotropic magnetic material sheet including filler particles oriented such that the short axes thereof are oriented in the thickness direction is rolled around a shaft to form a roll. The roll is cut along the direction perpendicular to the shaft into a large number of pieces, and these pieces are arranged in an annular shape to produce the annular portion 19a1.

A resin containing filler particles is applied by printing around the annular portion 19a1 formed as described above, thereby to complete the bottom cover layer 19a.

Next, through-holes are formed at predetermined positions in the magnetic sheets to be used as the insulating layers 20a1 to 20a7, so as to extend through the magnetic sheets in the direction of the axis T.

Next, a conductive paste made of a metal material (e.g. Ag) is applied by screen printing to the top surfaces of the magnetic sheets to be used as the insulating layers 20a1 to 20a7, and the metal paste is filled into the through-holes formed in the magnetic sheets. The metal material filled into the through-holes forms the vias Va1 to Va6.

Next, the magnetic sheets to be used as the insulating layers 20a1 to 20a7 are stacked together to form a coil laminate to be used as the insulator portion 20a. The magnetic sheets to be used as the insulating layers 20a1 to 20a7 are stacked together such that the conductive patterns 25a1 to 25a7 formed on the magnetic sheets are each electrically connected to adjacent conductive patterns through the vias Va1 to Va6.

Next, the magnetic sheets for forming the top cover layer 18a are stacked together to form a top cover layer laminate that corresponds to the top cover layer 18a, and the magnetic sheets for forming the bottom cover layer 19a are stacked together to form a bottom cover layer laminate that corresponds to the bottom cover layer 19a.

The same steps are performed to form a coil laminate to be used as the insulator portion 20b, a top cover layer laminate corresponding to the top cover layer 18b, and the bottom cover layer laminate corresponding to the bottom cover layer 19b.

Next, the bottom cover layer laminate to be used as the bottom cover layer 19b, the coil laminate to be used as the insulator portion 20b, the top cover layer laminate to be used as the top cover layer 18b, the bottom cover layer laminate to be used as the bottom cover layer 19a, the coil laminate to be used as the insulator portion 20a, and the top cover layer laminate to be used as the top cover layer 18a are stacked together in this order and bonded together by thermal compression using a pressing machine to obtain a body laminate.

Next, the body laminate is segmented to a desired size by using a cutter such as a dicing machine or a laser processing machine to obtain a chip laminate corresponding to the insulator body 11a. Next, the chip laminate is degreased and then heated.

Next, a conductive paste is applied to both end portions of the heated chip laminate to form the external electrode 21, the external electrode 22, the external electrode 23, and the external electrode 24. Thus, the coil component 1 is obtained.

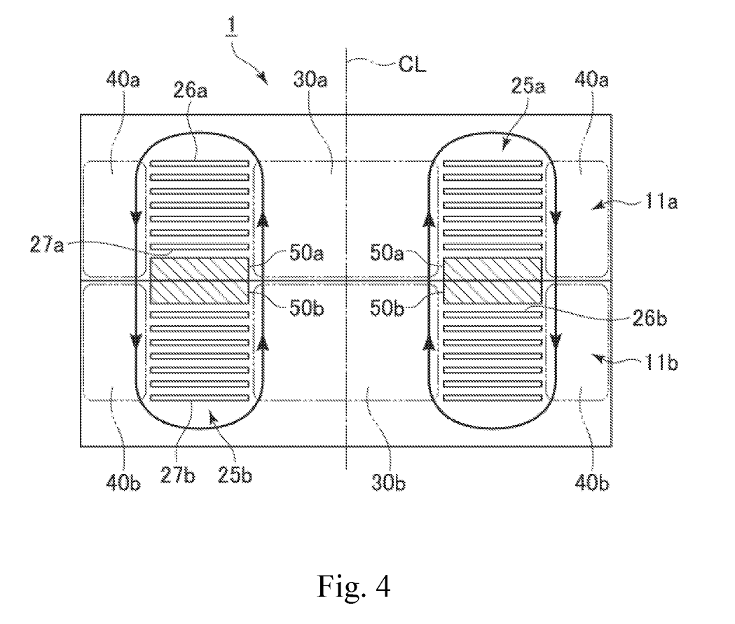

Next, a description is given of magnetic flux generated in the coil component 1 with reference to FIG. 4. FIG. 4 schematically shows a cross section of the coil component of FIG. 1 cut along the line I-I. In FIG. 4, the magnetic flux (the lines of magnetic force) generated from the coil conductor is represented by arrows. In FIG. 4, the boundaries between the individual insulating layers are omitted for convenience of description. Further, the external electrodes 21 to 24 are also not shown.

As shown, the coil conductor 25a is wound around the coil axis CL. The coil axis CL is an imaginary line that extends in parallel to the axis T in FIG. 1. Likewise, the coil conductor 25b is also wound around the coil axis CL. The coil conductor 25a has a top surface 26a and a bottom surface 27a, the top surface 26a constituting one end of the coil conductor 25a in the direction of the coil axis CL, the bottom surface 27a constituting the other end of the coil conductor 25a in the direction of the coil axis CL. The coil conductor 25b has a top surface 26b and a bottom surface 27b, the top surface 26b constituting one end of the coil conductor 25b in the direction of the coil axis CL, the bottom surface 27b constituting the other end of the coil conductor 25b in the direction of the coil axis CL. The coil conductor 25a is disposed such that the bottom surface 27a thereof is opposed to the top surface 26b of the coil conductor 25b.

The insulator body 11a includes a core portion 30a positioned inside the coil conductor 25a, an outer peripheral portion 40a positioned outside the coil conductor 25a, and an intermediate portion 50a positioned between the bottom surface 27a of the coil conductor 25a and the top surface 26b of the coil conductor 25b. The core portion 30a and the outer peripheral portion 40a are constituted by the insulator portion 20a and the portion of the bottom cover layer 19a other than the annular portion 19a1. The intermediate portion 50a is constituted by the annular portion 19a1.

The insulator body 11b includes a core portion 30b positioned inside the coil conductor 25b, an outer peripheral portion 40b positioned outside the coil conductor 25b, and an intermediate portion 50b positioned between the top surface 26b of the coil conductor 25b and the bottom surface 27a of the coil conductor 25a. The core portion 30b and the outer peripheral portion 40b are constituted by the insulator portion 20b and the portion of the top cover layer 18b other than the annular portion 18b1. The intermediate portion 50b is constituted by the annular portion 18b1.

As described above, the magnetic permeability of the annular portion 19a1 in the direction perpendicular to the axis T is smaller than those of the insulator portion 20a and the bottom cover layer 19a in the direction parallel to the coil axis CL. Therefore, the magnetic permeability of the intermediate portion 50a in the direction perpendicular to the col axis CL is smaller than those of the core portion 30a and the outer peripheral portion 40a in the direction parallel to the coil axis CL. The magnetic permeability of the intermediate portion 50a in any direction perpendicular to the coil axis CL and centered at the coil axis CL may be smaller than those of the core portion 30a and the outer peripheral portion 40a in the direction parallel to the coil axis CL, and the average magnetic permeability of the intermediate portion 50a in the direction perpendicular to the coil axis CL may be smaller than the average magnetic permeability of the core portion 30a in the direction parallel to the coil axis CL and the average magnetic permeability of the outer peripheral portion 40a in the direction parallel to the coil axis CL. The average magnetic permeability of the intermediate portion 50a in the direction perpendicular to the coil axis CL may be the average of the magnetic permeability in a first direction perpendicular to the coil axis CL and the magnetic permeability in a second direction perpendicular to the coil axis CL. The first direction and the second direction may be perpendicular to each other. For example, the first direction is the direction of the axis W, and the second direction is the direction of the axis L.

Likewise, the magnetic permeability of the annular portion 18b1 in the direction perpendicular to the coil axis CL is smaller than those of the insulator portion 20b and the top cover layer 18b in the direction parallel to the coil axis CL. Therefore, the magnetic permeability of the intermediate portion 50b in the direction perpendicular to the col axis CL is smaller than those of the core portion 30b and the outer peripheral portion 40b in the direction parallel to the coil axis CL. The magnetic permeability of the intermediate portion 50b in any direction perpendicular to the coil axis CL and centered at the coil axis CL may be smaller than those of the core portion 30b and the outer peripheral portion 40b in the direction parallel to the coil axis CL, and the average magnetic permeability of the intermediate portion 50b in the direction perpendicular to the coil axis CL may be smaller than the average magnetic permeability of the core portion 30b in the direction parallel to the coil axis CL and the average magnetic permeability of the outer peripheral portion 40b in the direction parallel to the coil axis CL. The average magnetic permeability of the intermediate portion 50b in the direction perpendicular to the coil axis CL may be the average of the magnetic permeability in a first direction perpendicular to the coil axis CL and the magnetic permeability in a second direction perpendicular to the coil axis CL. The first direction and the second direction may be perpendicular to each other. For example, the first direction is the direction of the axis W, and the second direction is the direction of the axis L.

In the coil component 1, the magnetic flux generated from the electric current flowing through the coil conductor 25a passes through the core portion 30a, the top cover layer 18a, and the outer peripheral portion 40a of the coil unit 1a and enters the outer peripheral portion 40b of the coil unit 1b. In the coil unit 1b, the magnetic flux passes through the outer peripheral portion 40b, the bottom cover layer 19b, and the core portion 30b, and returns to the core portion 30a of the coil unit 1a. Thus, the magnetic flux generated from the electric current flowing through the coil conductor 25a runs in a closed magnetic path that extends through the core portion 30a, the top cover layer 18a, the outer peripheral portion 40a, the outer peripheral portion 40b, the bottom cover layer 19b, and the core portion 30b and returns to the core portion 30a. Since the magnetic permeabilities of the intermediate portion 50a and the intermediate portion 50b in the direction perpendicular to the coil axis are smaller than those of the outer peripheral portion 40a and the outer peripheral portion 40b in the direction parallel to the coil axis CL, the magnetic flux passing through the outer peripheral portion 40a runs in a path that extends through the outer peripheral portion 40a in parallel to the coil axis CL and enters the outer peripheral portion 40b, not in a path that extends through the intermediate portion 50a or the intermediate portion 50b and returns to the core portion 30a. The magnetic flux generated from the electric current flowing through the coil conductor 25b also runs in a similar closed magnetic path. Therefore, there is less leakage magnetic flux occurring between the coil conductor 25a and the coil conductor 25b in the coil component 1. Accordingly, the coil component 1 achieves an improved coupling coefficient as compared to conventional magnetic coupling coil components liable to leakage magnetic flux between coil conductors.

In one embodiment of the present invention, the annular portion 19a1 has a larger resistance value than the insulator portion 20a and the bottom cover layer 19a, and therefore, the intermediate portion 50a has a larger resistance value than the core portion 20a and the outer peripheral portion 40a. The annular portion 18b1 has a larger resistance value than the insulator portion 20b and the top cover layer 18b, and therefore, the intermediate portion 50b has a larger resistance value than the core portion 20b and the outer peripheral portion 40b. Thus, even when the intermediate portion 50a and the intermediate portion 50b have a small thickness, electric insulation between the coil conductor 25a and the coil conductor 25b can be ensured.

The coil component 1, which is formed by the lamination process, is more susceptible to downsizing than conventional assembled coupled inductors.

When filler particles constituted by metal magnetic particles are contained in the top cover layer 18a, the insulator portion 20a, the bottom cover layer 19a, the top cover layer 18b, the insulator portion 20b, and the bottom cover layer 19b, there is less possibility of magnetic saturation in the closed magnetic path that extends through the core portion 30a, the top cover layer 18a, the outer peripheral portion 40a, the outer peripheral portion 40b, the bottom cover layer 19b, and the core portion 30b, as compared to the case where the filler particles are formed of a ferrite material. Therefore, a magnetic gap is not necessary in the closed magnetic path. As a result, the magnetic flux leakage is small.

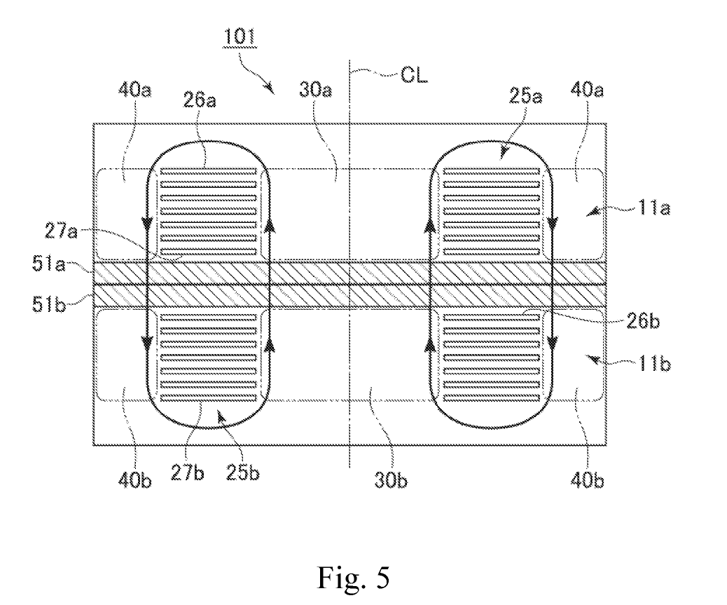

Next, with reference to FIG. 5, a description is given of a coil component 101 according to another embodiment of the present invention. The coil component 101 shown in FIG. 5 includes an intermediate portion 51a in place of the intermediate portion 50a of the coil component 1 and includes an intermediate portion 51b in place of the intermediate portion 50b.

In the embodiment of FIG. 5, the intermediate portion 51a is constituted by the bottom cover layer 19a, and the intermediate portion 51b is constituted by the top cover layer 18b. The bottom cover layer 19a and the top cover layer 18b are formed of an anisotropic magnetic material having an easy magnetization direction parallel to the coil axis CL. The magnetic permeabilities of the intermediate portion 51a and the intermediate portion 51b in the direction perpendicular to the coil axis CL are smaller than those of the outer peripheral portion 40a and the outer peripheral portion 40b in the direction parallel to the coil axis CL.

The bottom cover layer 19a and the top cover layer 18b formed of this anisotropic material are stacked together with other layers to produce the coil component 101 shown in FIG. 5. That is, the coil component 101 is produced by stacking the bottom cover layer 19b, the insulator portion 20b, the top cover layer 18b, the bottom cover layer 19a, the insulator portion 20a, and the top cover layer 18a in this order and perform a heat treatment.

In the coil component 101, the magnetic flux generated from the electric current flowing through the coil conductor 25a passes through the core portion 30a, the top cover layer 18a, the outer peripheral portion 40a, and the intermediate portion 51a of the coil unit 1a and enters the intermediate portion 51b of the coil unit 1b. In the coil unit 1b, the magnetic flux passes through the intermediate portion 51b, the outer peripheral portion 40b, the bottom cover layer 19b, the core portion 30b, and the intermediate portion 51b, and returns to the intermediate portion 51a and the core portion 30a of the coil unit 1a. Since the magnetic permeabilities of the intermediate portion 51a and the intermediate portion 51b in the direction perpendicular to the coil axis CL are smaller than those of the outer peripheral portion 40a and the outer peripheral portion 40b in the direction parallel to the coil axis CL, the magnetic flux passing through the outer peripheral portion 40a runs in a path that extends through the outer peripheral portion 40a in parallel to the coil axis CL and enters the outer peripheral portion 40b, not in a path that extends through the intermediate portion 51a or the intermediate portion 51b and returns to the core portion 30a. Therefore, there is less leakage magnetic flux occurring between the coil conductor 25a and the coil conductor 25b in the coil component 101. Although the intermediate portion 51a and the intermediate portion 51b are interposed in the closed magnetic path, the easy magnetization direction of the intermediate portion 51a and the intermediate portion 51b is the same as the direction of the magnetic flux, and therefore, the effective permeability of the coil component 101 is not degraded by the intermediate portion 51a and the intermediate portion 51b.

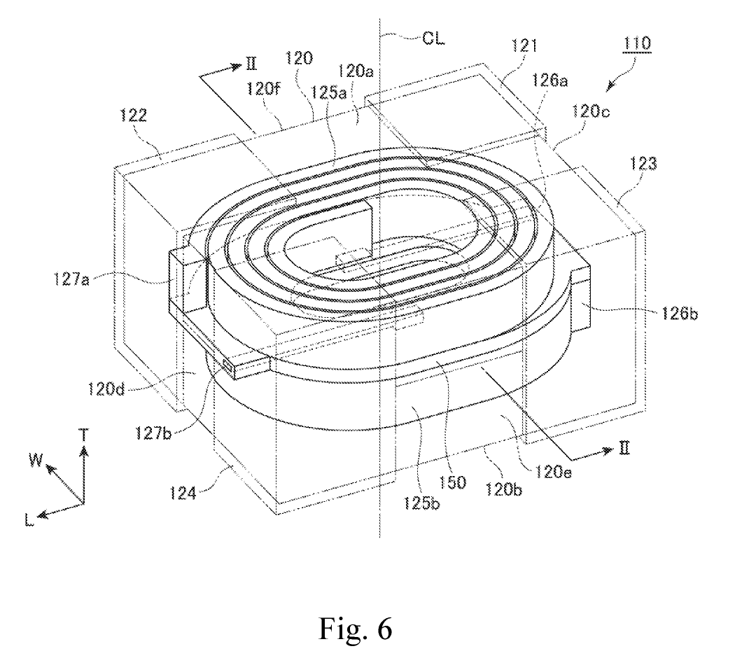

Next, with reference to FIG. 6, a description is given of a coil component 110 according to still another embodiment of the present invention. The coil component 110 is different from the coil component 1 in that in coil component 110, the coil is formed as a planar coil by a thin film process, whereas in the coil component 1, the coil is formed in a spiral shape by the lamination process.

As shown, the coil component 110 according to one embodiment of the present invention includes an insulator body 120, an insulating substrate 150, a coil conductor 125a formed on the top surface of the insulating substrate 150, a coil conductor 125b formed on the bottom surface of the insulating substrate 150, an external electrode 121 electrically connected to one end of the coil conductor 125a, an external electrode 122 electrically connected to the other end of the coil conductor 125a, an external electrode 123 electrically connected to one end of the coil conductor 125b, and an external electrode 124 electrically connected to the other end of the coil conductor 125b.

The insulating substrate 150 is formed of an anisotropic magnetic material having an easy magnetization direction parallel to the coil axis CL. The anisotropic magnetic material is, for example, a composite magnetic material containing a resin and flat-shaped filler particles. The resin is a thermosetting resin having an excellent insulating quality. More specifically, the resin contained in the insulating substrate 150 may be the same as that contained in the insulating layers 20a1 to 20a7, and detailed description thereof will be omitted.

The filler particles contained in the insulating substrate 150 are contained in the resin so as to assume such a position that the longest axes thereof are parallel to the coil axis CL and the short axes thereof are perpendicular to the coil axis CL. With the filler particles assuming such a position, the magnetic permeability of the insulating substrate 150 in the direction parallel to the coil axis CL is larger than that in the direction perpendicular to the coil axis CL. Thus, the insulating substrate 150 has an easy magnetization direction parallel to the coil axis CL and a hard magnetization direction perpendicular to the coil axis CL. To ensure that the insulating substrate 150 has an easy magnetization direction parallel to the coil axis CL and a hard magnetization direction perpendicular to the coil axis CL, it is not necessary that all the filler particles contained in the insulating substrate 150 have the longest axes thereof oriented accurately perpendicular to the axis T. The filler particles contained in the insulating substrate 150 may be the same as those contained in the insulating layers 20a1 to 20a7, and detailed description thereof will be omitted.

In one embodiment of the present invention, the insulating substrate 150 has a larger resistance value than the insulator body 120. Thus, even when the insulating substrate 150 has a small thickness, electric insulation between the coil conductor 125a and the coil conductor 125b can be ensured.

The coil conductor 125a is formed in a pattern on the top surface of the insulating substrate 150. In the embodiment shown, the coil conductor 125a includes a turning portion having a plurality of turns around the coil axis CL.

Likewise, the coil conductor 125b is formed in a pattern on the bottom surface of the insulating substrate 150. In the embodiment shown, the coil conductor 125b includes a turning portion having a plurality of turns around the coil axis CL. In one embodiment of the present invention, the top surface of the turning portion of the coil conductor 125b is opposed to the bottom surface of the turning portion of the coil conductor 125a.

The coil conductor 125a has a lead conductor 126a on one end thereof and a lead conductor 127a on the other end. The coil conductor 125a is electrically connected to the external electrode 121 via the lead conductor 126a and is electrically connected to the external electrode 122 via the lead conductor 127a. Likewise, the coil conductor 125b has a lead conductor 126b on one end thereof and a lead conductor 127b on the other end. The coil conductor 125b is electrically connected to the external electrode 123 via the lead conductor 126b and is electrically connected to the external electrode 124 via the lead conductor 127b.

The coil conductor 125a and the coil conductor 125b are formed by forming a patterned resist on the surface of the insulating substrate 150 and filling a conductive metal into an opening in the resist by plating.

In one embodiment of the present invention, the insulator body 120 has a first principal surface 120a, a second principal surface 120b, a first end surface 120c, a second end surface 120d, a first side surface 120e, and a second side surface 120f. The outer surface of the insulator body 120 is defined by these six surfaces.

In one embodiment of the present invention, the insulator body 120 is made of a resin containing a large number of filler particles dispersed therein. In another embodiment of the present invention, the insulator body 120 is made of a resin containing no filler particles. In one embodiment of the present invention, the resin contained in the insulator body 120 is a thermosetting resin having an excellent insulating quality.

Examples of a thermosetting resin used to form the insulator body 120 include benzocyclobutene (BCB), an epoxy resin, a phenolic resin, an unsaturated polyester resin, a vinyl ester resin, a polyimide resin (PI), a polyphenylene ether (oxide) resin (PPO), a bismaleimide-triazine cyanate ester resin, a fumarate resin, a polybutadiene resin, and a polyvinyl benzyl ether resin.

In one embodiment of the present invention, the filler particles contained in the insulator body 120 may be the same as those contained in the insulating layers 20a1 to 20a7.

The external electrode 121 and the external electrode 123 are provided on the first end surface 120c of the insulator body 120. The external electrode 122 and the external electrode 124 are provided on the second end surface 120d of the insulator body 120. As shown, these external electrodes extend onto the top surface 120a and the bottom surface 120b of the insulator body 120.

Next, a description is given of an example of a production method of the coil component 110. The coil component 110 can be produced by, for example, a thin film process. First, the insulating substrate 150 is prepared. Next, a photoresist is applied to the top surface and the bottom surface of the insulating substrate 150. Next, the conductive pattern of the coil conductor 125a is transferred onto the top surface of the insulating substrate 150 by exposure using a photomask, and development is performed. As a result, a resist having an opening pattern for forming the coil conductor 125a is formed on the top surface of the insulating substrate 150. Likewise, a resist having an opening pattern for forming the coil conductor 125b is formed on the bottom surface of the insulating substrate 150. Next, a conductive metal is filled into each of the opening patterns by plating. Next, the resists are removed by etching to form the coil conductor 125a on the top surface of the insulating substrate 150 and form the coil conductor 125b on the bottom surface of the insulating substrate 150.

Next, the insulator body 120 is formed on both surfaces of the insulating substrate 150 having the coil conductor 125a and the coil conductor 125b formed thereon. The insulator body 120 is formed by lamination, pressing, or the like using a resin containing a filler.

Next, the body laminate is segmented to a desired size by using a cutter such as a dicing machine or a laser processing machine to obtain a laminate having a size of a unit component corresponding to the insulator body 120. Next, the external electrodes 121 to 124 are formed on the segmented laminate. Each of the external electrodes is formed by applying a conductive paste on the surface of the insulator body 120 to form a base electrode and forming a plating layer on the surface of the base electrode. The plating layer is constituted by, for example, two layers including a nickel plating layer containing nickel and a tin plating layer containing tin.

The coil component 110 according to one embodiment of the present invention is obtained through the above steps. The above-described method for producing the coil component 110 is merely one example, which does not limit methods for producing the coil component 110.

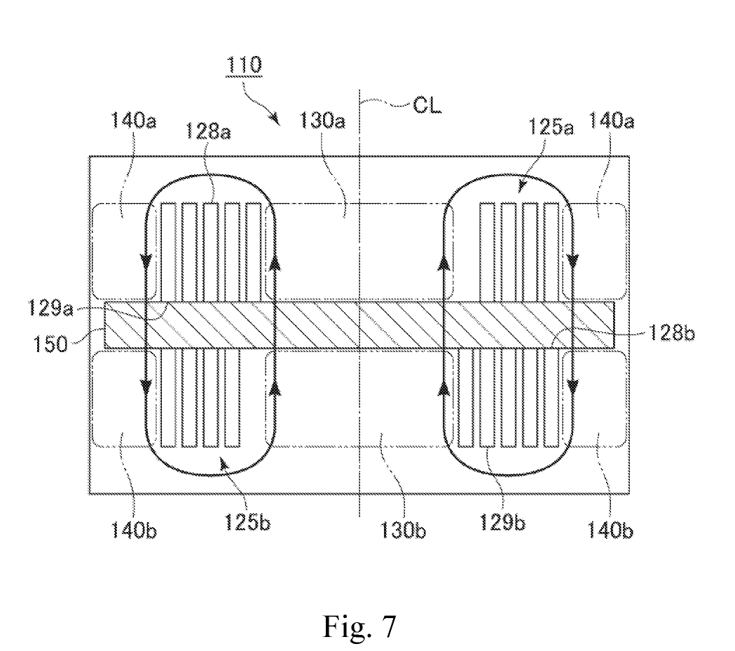

Next, a description is given of magnetic flux generated in the coil component 110 with reference to FIG. 7. FIG. 7 schematically shows a cross section of the coil component of FIG. 6 cut along the line II-II. In FIG. 7, the magnetic flux (the lines of magnetic force) generated from the coil conductor is represented by arrows. In FIG. 7, the external electrodes are omitted for convenience of description.

As shown, the coil conductor 125a has a top surface 128a and a bottom surface 129a, the top surface 128a constituting one end of the coil conductor 125a in the direction of the coil axis CL, the bottom surface 129a constituting the other end of the coil conductor 125a in the direction of the coil axis CL. The coil conductor 125b has a top surface 128b and a bottom surface 129b, the top surface 128b constituting one end of the coil conductor 125b in the direction of the coil axis CL, the bottom surface 129b constituting the other end of the coil conductor 125b in the direction of the coil axis CL. As shown, the coil conductor 125a is disposed such that the bottom surface 129a thereof is opposed to the top surface 128b of the coil conductor 125b.

The insulator body 120 includes a core portion 130a positioned inside the coil conductor 125a, an outer peripheral portion 140a positioned outside the coil conductor 125a, a core portion 130b positioned inside the coil conductor 125b, and an outer peripheral portion 140b positioned outside the coil conductor 125b.

In the coil component 110, the magnetic flux generated from the electric current flowing through the coil conductor 125a runs in a closed magnetic path shown by the arrows in FIG. 7 that extends through the core portion 130a, the outer peripheral portion 140a, the insulating substrate 150 (the portion positioned outside the coil conductor 125a and the coil conductor 125b), the outer peripheral portion 140b, the core portion 130b, and the insulating substrate 150 (the portion positioned inside the coil conductor 125a and the coil conductor 125b) and returns to the core portion 130a. Since the magnetic permeability of the insulating substrate 150 in the direction perpendicular to the coil axis CL is smaller than those of the outer peripheral portion 140a, the outer peripheral portion 140b, and the insulating substrate 150 in the direction parallel to the coil axis CL, the magnetic flux passing through the outer peripheral portion 140a runs in a path that extends through the insulating substrate 150 in parallel to the coil axis CL and enters the outer peripheral portion 140b, not in a path that extends through the insulating substrate 150 in the direction perpendicular to the coil axis CL and returns to the core portion 130a. The magnetic flux generated from the electric current flowing through the coil conductor 125b also runs in a similar closed magnetic path. Therefore, there is less leakage magnetic flux occurring between the coil conductor 125a and the coil conductor 125b in the coil component 110. Accordingly, the coil component 110 also achieves an improved coupling coefficient as compared to conventional magnetic coupling coil components liable to leakage magnetic flux between coil conductors.

The coil component 110, which is formed by the thin film process, is more susceptible to downsizing than assembled coupled inductors.

The dimensions, materials, and arrangements of the various constituents described in this specification are not limited to those explicitly described for the embodiments, and the various constituents can be modified to have any dimensions, materials, and arrangements within the scope of the present invention. The constituents other than those explicitly described herein can be added to the described embodiments; and part of the constituents described for the embodiments can be omitted.

What is claimed is:

1. A coil component, comprising:
an insulator body;
a first coil conductor embedded in the insulator body and wound around a coil axis; and
a second coil conductor embedded in the insulator body and wound around the coil axis,
wherein a first coil surface of the first coil conductor is opposed to a second coil surface of the second coil conductor,
the insulator body includes:
an intermediate portion disposed between the first coil surface and the second coil surface;
a core portion disposed inside the first coil conductor and the second coil conductor; and
an outer peripheral portion disposed outside the first coil conductor and the second coil conductor, and
a magnetic permeability of the intermediate portion in a direction perpendicular to the coil axis is smaller than those of the core portion and the outer peripheral portion in a direction parallel to the coil axis.

2. The coil component of claim 1, wherein the intermediate portion is made of a non-magnetic material.

3. The coil component of claim 1, wherein the intermediate portion is made of an anisotropic magnetic material having an easy magnetization direction parallel to the coil axis.

4. The coil component of claim 1, wherein the intermediate portion has a larger resistance value than the core portion.

5. The coil component of claim 1, wherein the intermediate portion has a larger resistance value than the outer peripheral portion.

6. The coil component of claim 1, further comprising:
an intermediate layer disposed between the first coil conductor and the second coil conductor and made of an anisotropic magnetic material having an easy magnetization direction parallel to the coil axis,
wherein the core portion includes a first core portion disposed inside the first coil conductor and a second core portion disposed inside the second coil conductor, and
the outer peripheral portion includes a first outer peripheral portion disposed outside the first coil conductor and a second outer peripheral portion disposed outside the second coil conductor.

7. A coil component, comprising:
an insulator body;
an insulating substrate embedded in the insulator body;
a first coil conductor formed on one surface of the insulating substrate and wound around a coil axis; and
a second coil conductor formed on another surface of the insulating substrate and wound around the coil axis,
wherein a magnetic permeability of the insulating substrate in a direction perpendicular to the coil axis is smaller than that in a direction parallel to the coil axis.

8. The coil component of claim 7, wherein the insulating substrate is made of a non-magnetic material.

9. The coil component of claim 7, wherein the insulating substrate is made of an anisotropic magnetic material having an easy magnetization direction parallel to the coil axis.

10. The coil component of claim 7, wherein the insulating substrate has a larger resistance value than the insulator body.
